(19) United States
(12) Patent Application Publication
(10) Pub. No.: US 2022/0348353 A1
(43) Pub. Date: Nov. 3, 2022

(54) AIRPORT APPROACH ASSISTANCE SYSTEM AND METHOD

(71) Applicant: Airbus SAS, Blagnac (FR)

(72) Inventors: Jean-Jacques TOUMAZET, BLAGNAC (FR); Javier MANJON SANCHEZ, BLAGNAC (FR)

(21) Appl. No.: 17/730,299

(22) Filed: Apr. 27, 2022

(30) Foreign Application Priority Data
Apr. 29, 2021 (FR) 2104510

(51) Int. Cl. B64D 45/08; G08G 5/02; G06V 10/25; G06V 10/75; G06V 20/17; G06V 10/24

(52) U.S. Cl. CPC B64D 45/08; G08G 5/025; G06V 10/25; G06V 10/759; G06V 20/17; G06V 10/24

(57) ABSTRACT

An airport approach assistance system for aircraft includes a controller including electronic circuitry configured to: obtain a first image captured by a camera configured to capture images of a field of view ahead of the aircraft; obtain a second image stored in a database representing a runway where the aircraft is supposed to land; make changes to the first image and/or to the second image, in order to transpose them into a same spatial reference frame; extract a first region of interest from the first image, so as to isolate a landing area; compare the extracted first region of interest with a second region of interest associated with the second image; and generate a signal according to a comparison result. Thus, a pilot of the aircraft is assisted in confirming that the landing takes place on the expected landing runway.

### CROSS-REFERENCES TO RELATED APPLICATIONS

This application claims the benefit of the French patent application No. 2104510 filed on Apr. 29, 2021, the entire disclosures of which are incorporated herein by way of reference.

### FIELD OF THE INVENTION

The present invention relates to a system intended to be installed in an aircraft and to assist piloting in airport approaches. The present invention relates also to a method implemented by such a system. The present invention relates also to an aircraft with such a system installed.

### BACKGROUND OF THE INVENTION

When an aircraft pilot has to land the aircraft on a landing runway of an airport which has been assigned to it, the pilot must obviously take particular care to perform the landing on the landing runway concerned and not elsewhere in the airport, and, in particular, not on a taxiway.

It is therefore desirable to provide the pilot with an automatic assistance solution which makes it possible to confirm that the landing does indeed take place on the expected landing runway. It is even more desirable to provide a solution which is simple to implement and inexpensive.

### SUMMARY OF THE INVENTION

To this end, an airport approach assistance system for aircraft is proposed, including a controller comprising electronic circuitry configured to: obtain a first image captured by a camera configured to capture images of a field of view ahead of the aircraft; obtain a second image stored in a database representing a runway, called expected landing runway, where the aircraft is supposed to land; make changes to the first image and/or to the second image, in order to transpose them into a same spatial reference frame; extract a first region of interest from the first image, so as to isolate a landing area in the first image; compare the extracted first region of interest with a second region of interest associated with the second image; and generate a signal representative of an approach to a landing area which does not correspond to the expected landing runway when the first region of interest and the second region of interest do not match and/or a signal representative of an approach to a landing area which corresponds to the expected landing runway when the first region of interest and the second region of interest match. Thus, a pilot of the aircraft is assisted in confirming that the landing takes place on the expected landing runway.

According to a particular embodiment, the airport approach assistance system further includes a camera.

According to a particular embodiment, the airport approach assistance system further includes a database.

According to a particular embodiment, the changes to the first image and/or to the second image include reprojection operations.

According to a particular embodiment, the second images being images of the landing runway taken vertically and the first images being perspective images, the reprojection operations are operations of vertical reprojection of the first images, transforming them into equivalent images taken vertically. As a variant, the reprojection operations are operations of perspective reprojection of the second images, transforming them into equivalent images taken in perspective.

According to a particular embodiment, the electronic circuitry is configured to determine, as a function of the attitude of the aircraft, whether the aircraft is aligned on the expected landing runway, and, if not, generate the signal representative of an approach to a landing area which does not correspond to the expected landing runway.

According to a particular embodiment, the second region of interest of the second image is associated with a label representative of the content of the second region of interest, and the electronic circuitry is configured to check, using the label, that the aircraft is aligned on a landing runway.

Also proposed is an aircraft comprising a camera installed and configured to capture images of a field of view ahead of the aircraft, and the airport approach assistance system described above, in any one of these embodiments.

According to a particular embodiment, the electronic circuitry of the controller of the airport approach assistance system is configured to transmit the signal to a human-machine interface of the cockpit of the aircraft.

Also proposed is a method implemented by electronic circuitry of a controller of an airport approach assistance system for aircraft, including: obtaining a first image captured by a camera installed on the aircraft and configured to capture images of a field of view ahead of the aircraft; obtaining a second image stored in a database representing a runway, called expected landing runway, where the aircraft is supposed to land; making changes to the first image and/or to the second image, in order to transpose them into a same spatial reference frame; extracting a first region of interest from the first image, so as to isolate a landing area in the first image; comparing the extracted first region of interest with a second region of interest associated with the second image; and generating a signal representative of an approach to a landing area which does not correspond to the expected landing runway when the first region of interest and the second region of interest do not match and/or a signal representative of an approach to a landing area which corresponds to the expected landing runway when the first region of interest and the second region of interest match.

Also proposed is a computer program which can be executed by a processor. This computer program comprises instructions for implementing the abovementioned method when these instructions are executed by the processor. Also proposed is an information storage medium which stores such a computer program, and which is intended to be read by the processor in order to implement the method.

### BRIEF DESCRIPTION OF THE DRAWINGS

The abovementioned features of the invention, and others, will emerge more clearly on reading the following description of at least one exemplary embodiment, the description being given in relation to the attached drawings, in which:

FIG. 1 schematically illustrates, by a side view, an aircraft equipped with an airport approach assistance system;

FIG. 2A schematically illustrates a particular arrangement of the airport approach assistance system;

FIG. 2B schematically illustrates a particular arrangement of a controller of the airport approach assistance system;

FIG. 3 schematically illustrates an example of the hardware arrangement of the controller; and

FIG. 4 schematically illustrates an airport approach assistance algorithm.

### DETAILED DESCRIPTION OF THE PREFERRED EMBODIMENTS

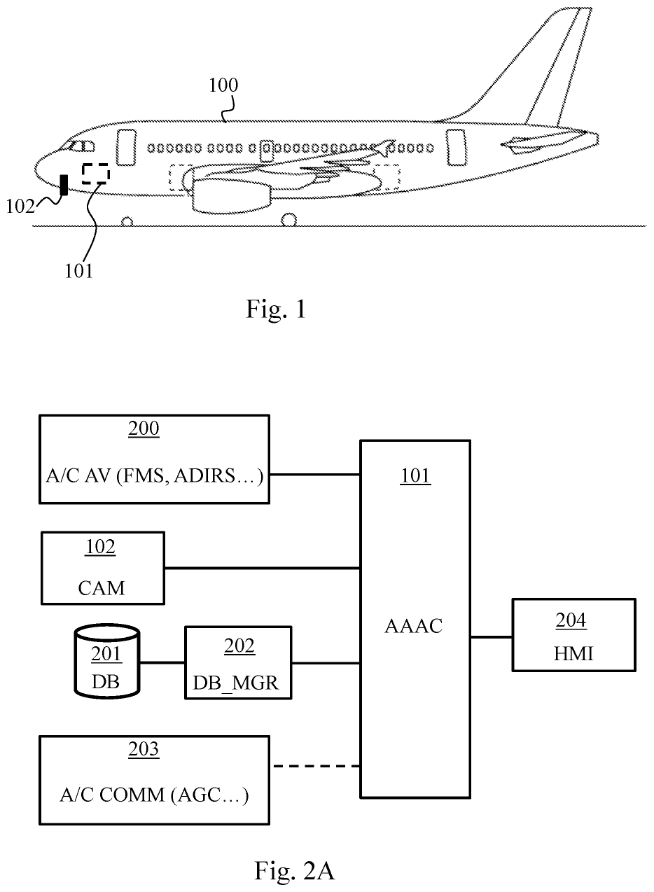

FIG. 1 schematically illustrates, by a side view, an aircraft 100. The aircraft 100 has an airport approach assistance system installed. The airport approach assistance system comprises an airport approach assistant controller AAAC 101.

The aircraft 100 also has a camera CAM 102 installed. The camera CAM 102 is installed on the aircraft 100, and is configured to capture images of a field of a view ahead of the aircraft 100. The field of view, also called visual field or viewing angle, corresponds to the space that the lens of the camera CAM 102 perceives when the lens fixes a point in space ahead of the aircraft 100. The camera CAM 102 can be installed at any point allowing observation ahead of the aircraft 100, such that, when the aircraft 100 is on approach to land, the camera CAM 102 captures images of the terrain (ground) on approach. According to a first particular embodiment, the camera CAM 102 is installed in the cockpit of the aircraft 100 so as to capture images through the windshield of the cockpit. According to a second particular embodiment, the camera CAM 102 is installed on the nose of the aircraft 100. According to a third particular embodiment, the camera CAM 102 is installed under the fuselage of the aircraft 100.

The camera CAM 102 is connected to the airport approach assistance system or is included in the airport approach assistance system. The camera CAM 102 is connected to the controller AAAC 101 and is configured to supply the controller AAAC 101 with captured images of the field of view ahead of the aircraft 100.

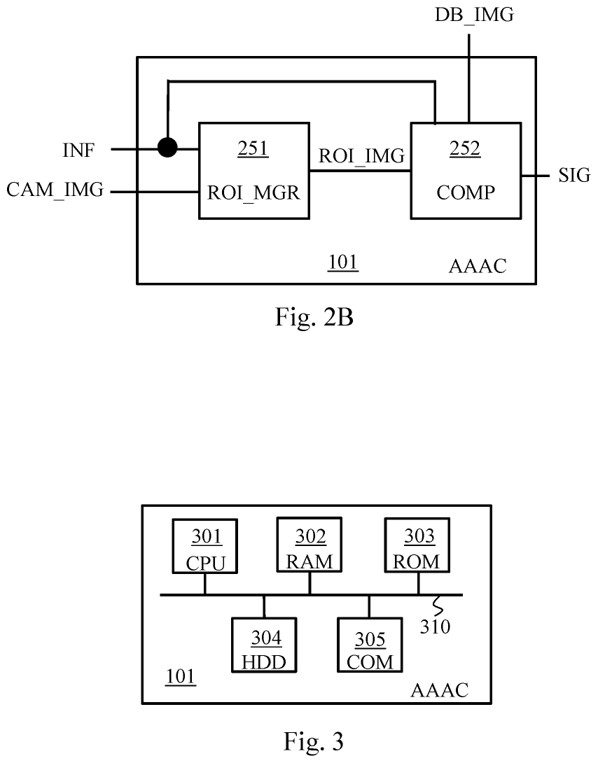

FIG. 2A schematically illustrates a particular arrangement of the airport approach assistance system. FIG. 2A shows the controller AAAC 101, which is connected to the camera CAM 102, to an avionics 200 of the aircraft 100 (denoted “A/C AV” in FIG. 2A), to a database manager 202 (denoted “DB_MGR” in FIG. 2A) and to a human-machine interface HMI 204.

The avionics 200 includes various piloting assistance electronic equipment items, and notably a flight management system FMS and an inertial referencing system, or “Air Data and Inertial Reference System”, ADIRS.

The human-machine interface HMI 204 is intended to allow interactions with one or more pilots of the aircraft 100, and, more particularly, to make it possible to broadcast (e.g., by display) information to the pilot or pilots. The human-machine interface HMI 204 is preferentially incorporated in the cockpit of the aircraft 100, and can be incorporated in the avionics 200. The human-machine interface HMI 204 is thus, for example, the primary flight display PFD of the cockpit. The human-machine interface HMI 204 can, as a variant, be a head-up display HUD or an augmented reality head-mounted display HMD. The human-machine interface HMI 204 can, as a variant, be a sound reproduction device, such as a loudspeaker. The arrangement of FIG. 2A therefore allows the controller AAAC 101 to transmit, subject to conditions (as detailed hereinbelow), a signal SIG to the pilot or pilots of the aircraft 100 using the human-machine interface HMI 204.

FIG. 2A also shows a communication system 203 (denoted “A/C COMM” in FIG. 2A) of the aircraft 100, preferentially including an air-ground communications AGC device. Thus, in addition to or as a variant of the signal SIG sent using the human-machine interface HMI 204, the arrangement of FIG. 2A allows the controller AAAC 101 to transmit, subject to conditions (as detailed hereinbelow), this signal SIG to the ground (e.g., to an air traffic control center) using the communication system 203.

In a particular embodiment, the signal SIG is transmitted to a control system of the avionics 200 responsible for managing go-around procedures in case of interruption of a landing of the aircraft 100 on final approach. The signal SIG can thus be used to configure an automatic go-around.

The database manager DB_MGR 202 is connected to a database DB 201. The database manager DB_MGR 202 and the database DB 201 can be incorporated in one and the same entity. The database manager DB_MGR 202 executes image search commands in the database DB 201 on instruction from the controller AAAC 101 and returns to the controller AAAC 101 one or more images resulting from the search.

The database DB 201 stores georeferenced images of airports and, more particularly, of landing runways of the airports. The images concerned are preferentially photos from the air. As a variant, the images concerned can be virtual images resulting from a modelling of the landing runways. The database DB 201 can be totally incorporated in a computer system of the aircraft 100. The database DB 201 can be partially incorporated in the computer system of the aircraft 100. In this case, before take-off, the database DB 201 partially installed in the aircraft 100 is updated with georeferenced images of airports located within a predefined perimeter of the flight plan of the aircraft 100. The database DB 201 can be totally incorporated, on the ground, in a computer system of an airline company for which the aircraft 100 operates. The database manager DB_MGR 202 then interacts with the controller AAAC 101 using air-ground communications AGC.

Thus, by virtue of the arrangement of FIG. 2A, the airport approach assistance system is configured such that the controller AAAC 101 receives images from the camera CAM 102, and images obtained from the database DB 201. The images obtained from the database DB 201 correspond to images of an airport runway on which the aircraft 100 is supposed to land, in light of a programming of the avionics 200 of the aircraft 100. The controller AAAC 101 manipulates the images from the camera CAM 102, and possibly the images obtained from the database DB 201, in order to place them in a same spatial reference frame to allow a pertinent comparison of their respective contents and thus determine whether the aircraft 100 is on approach to the expected landing runway.

FIG. 2B schematically illustrates a particular arrangement of the controller AAAC 101. The controller AAAC 101 then comprises a region-of-interest manager ROI_MGR 251, and a comparator COMP 252.

The controller AAAC 101 is configured such that the region-of-interest manager ROI_MGR 251 receives images CAM_IMG captured by the camera CAM 102. The controller AAAC 101 is configured such that the region-of-interest manager ROI_MGR 251 receives all or part of a set of information INF originating from the avionics 200 of the aircraft 100, to allow the region-of-interest manager ROI_MGR 251 to try to extract at least one region of interest ROI from the images CAM_IMG and possibly perform reprojection operations on the images CAM_IMG. The region-of-interest manager ROI_MGR 251 is configured to supply as output images ROI_IMG resulting from the extraction of the region or regions of interest ROI. Preferentially, the images ROI_IMG are the images CAM_IMG, possibly modified by the reprojection operations, to which are added metadata describing the extracted region or regions of interest ROI (in as much as such extraction was possible).

The information INF supplied by the avionics 200 to the controller AAAC 101 includes the position (geographic) of the aircraft 100 and the attitude (orientation in space) of the aircraft 100, as well as georeferencing data of the airport runway on which the aircraft 100 is supposed to land.

The controller AAAC 101 is configured such that the comparator COMP 252 receives images DB_IMG supplied by the database DB 201 via the database manager DB_MGR 202. The controller AAAC 101 is configured in such a way that the comparator COMP 252 also receives the images ROI_IMG supplied by the region-of-interest manager ROI_MGR 251.

The controller AAAC 101 is configured so as to supply as output a signal SIG representative of the result of a comparison, by the comparator COMP 252, between the images DB_IMG supplied by the database DB 201 via the database manager DB_MGR 202 and the images supplied by the region-of-interest manager ROI_MGR 251. To allow the comparator COMP 252 to request, from the database manager DB_MGR 202, images of the airport runway on which the aircraft 100 is supposed to land, and possibly manipulate these images for them to be aligned and compared with the images ROI_IMG, the controller AAAC 101 is configured such that the comparator COMP 252 receives all or part of the set of information INF originating from the avionics 200 of the aircraft 100.

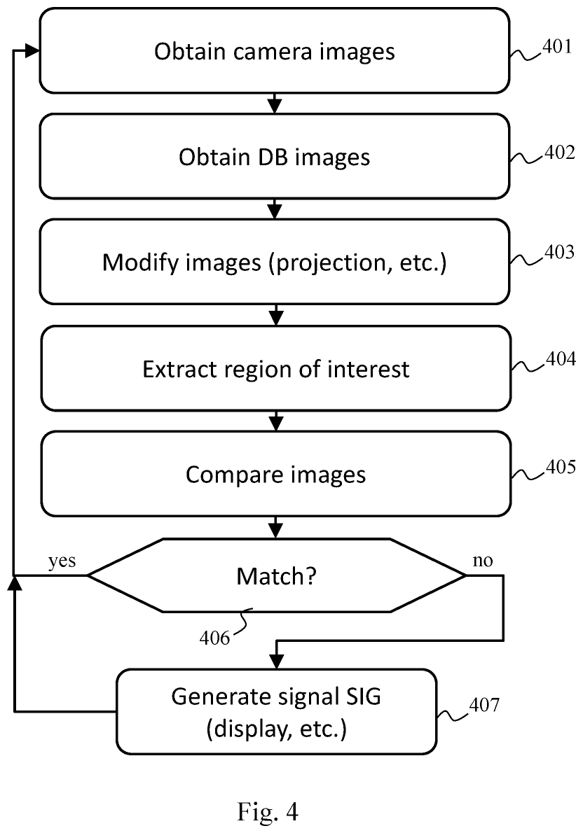

More comprehensive details on the operation of the controller AAAC 101, and more particularly of the region-of-interest manager ROI_MGR 251 and of the comparator COMP 252, are provided hereinbelow in relation to FIG. 4.

FIG. 3 schematically illustrates an example of hardware architecture of the controller AAAC 101, which then comprises, linked by a communication bus 300: a processor or CPU (“Central Processing Unit”) 301; a random access memory RAM 302, a read only memory ROM 303, for example a Flash memory; a data storage device, such as a hard disk drive HDD, or a storage medium reader, such as an SD (“Secure Digital”) card reader 304; at least one communication interface 305 allowing the controller AAAC 101 to interact in the airport approach assistance system and with other elements of the aircraft 100, such as the avionics 200 for example.

The processor 301 is capable of executing instructions loaded into the RAM 302 from the ROM 303, from an external memory (not represented), from a storage medium, such as an SD card, or from a communication network (not represented). When the controller AAAC 101 is powered up, the processor 301 is capable of reading instructions from the RAM 302 and of executing them. These instructions form a computer program causing the implementation, by the processor 301, of the behaviors, steps and algorithms described here.

All or part of the behaviors, steps and algorithms described here can thus be implemented in software form through execution of a set of instructions by a programmable machine, such as a DSP (“Digital Signal Processor”) or a microcontroller, or be implemented in hardware form by a machine or a dedicated component (“chip”), such as an FPGA (“Field-Programmable Gate Array”) or an ASIC (“Application-Specific Integrated Circuit”). Generally, the controller AAAC 101 comprises electronic circuitry arranged and configured to implement the behaviors, steps and algorithms described here.

FIG. 4 schematically illustrates an airport approach assistance algorithm implemented by the controller AAAC 101. The algorithm of FIG. 4 is executed after a landing runway of an airport has been selected in the avionics 200, typically by configuration of the flight management system FMS.

In a step 401, the controller AAAC 101 obtains images CAM_IMG captured by the camera CAM 102. In the particular arrangement of FIG. 3, the step 401 is performed by the region-of-interest manager ROI_MGR 251.

In a step 402, the controller AAAC 101 obtains at least one image DB_IMG which is contained in the database DB 201, and which is associated with the airport landing runway which has been selected in the avionics 200. As already indicated, the images DB_IMG are prestored in a database installed in the aircraft 100 or are obtained in flight, after selection of the landing runway concerned in the avionics 200 (configuration of the flight management system FMS), using air-ground communications. In the particular arrangement of FIG. 3, the step 402 is performed by the comparator COMP 252.

In a step 403, the controller AAAC 101 makes changes to the images CAM_IMG and/or the images DB_IMG, in order to transpose them into a same spatial reference frame. These changes can include translations, rotations, etc. In the particular arrangement of FIG. 3, the changes possibly added to the images CAM_IMG are made by the region-of-interest manager ROI_MGR 251 and the changes possibly added to the images DB_IMG are made by the comparator COMP 252.

More particularly, the changes of the step 403 include reprojection operations.

According to a first embodiment, the images IMG_DB are images of the landing runway taken vertically and images CAM_IMG are perspective images. Operations of vertical reprojection of the images CAM_IMG are then performed by the region-of-interest manager ROI_MGR 251, thus allowing the images CAM_IMG to be transformed into equivalent images taken vertically. For this, the region-of-interest manager ROI_MGR 251 uses the position and the attitude (orientation) of the aircraft, and the geographic coordinates of the landing runway concerned.

According to a second embodiment, the images IMG_DB are images of the landing runway taken vertically and the images CAM_IMG are perspective images. But, in this case, operations of perspective reprojection of the images DB_IMG are performed by the comparator COMP 252, thus allowing the images DB_IMG to be transformed into equivalent perspective images. For this, the comparator COMP 252 also uses the position and the attitude (orientation) of the aircraft, and the geographic coordinates of the landing runway concerned.

Other reprojection operations can be performed as a variant, for example when the images IMG_DB are also images of the landing runway taken in perspective, but probably from a viewing angle different from that by which the images CAM_IMG were allowed to be captured.

The reprojection operations are trivial geometric conversions and are not more fully described here.

In a particular embodiment, the changes to the images CAM_IMG and/or the images DB_IMG include operations of scaling with respect to one another.

In a step 404, the controller AAAC 101 performs region-of-interest ROI extraction operations on the images CAM_IMG, so as to isolate a landing area in the images, and thus generate the abovementioned images ROI_IMG. The region of interest ROI concerned is a polygonal portion of the images CAM_IMG which includes the landing area. The landing area has characteristics of form and of texture that are recognizable in the images from the air which allow the region of interest ROI concerned to be extracted through the application of image processing techniques. In particular, the landing runway in an image is a rectangle that is long in perspective, with a strong contrast between its edges and the immediate environment. Thus, the region-of-interest ROI extraction operations on the images CAM_IMG include highlighting changes of brightness (contrasts) in the images CAM_IMG concerned, then searching for the intersections between horizontal and vertical contrasts, in order finally to search for four of these intersections which form a rectangle that is long in perspective. Thus, for example, the region of interest ROI isolates a landing area composed of the landing runway with a margin of 50 meters on each side.

In a particular embodiment, the controller AAAC 101 performs operations of recentering of the region of interest ROI representative of the isolated landing area.

In a particular embodiment, the controller AAAC 101 also performs operations of extraction of at least one region of interest ROI representative of significant elements around the region of interest ROI representative of the isolated landing area. That then makes it possible to compare these regions of interest ROI representative of significant elements (buildings, etc.) with corresponding regions of interest ROI in the images DB_IMG, and thus allow two landing runways which appear similar to be distinguished.

In the particular arrangement of FIG. 3, the region-of-interest ROI extraction operations on the images CAM_IMG are performed by the region-of-interest manager ROI_MGR 251.

The images DB_IMG are also accompanied by region-of-interest ROI information, which is preferentially predetermined and stored in association with the images DB_IMG in the database DB 201. This region-of-interest ROI information associated with the images DB_IMG supplied to the controller AAAC 101 delimits a landing area which includes the landing runway on which the aircraft 100 is supposed to land. For example, the region of interest ROI associated with each image DB_IMG isolates a landing area composed of the landing runway concerned with a margin of 50 meters on each side. The region of interest ROI or other complementary regions of interest can include buildings, or any other distinctive element in the environment of the landing runway concerned. That provides supplementary referencing information, notably advantageous when the airports have several parallel runways. Labels, according to a predefined naming, affixed to the regions of interest ROI of the images DB_IMG, can be used for this. Such labels can also be used to confirm that the aircraft 100 is actually aligned on a landing runway (and more particularly on the expected landing runway), as described later. This region-of-interest ROI information is obtained according to the same rules as in the region-of-interest ROI extraction operations on the images CAM_IMG, such that the regions of interest ROI of the images CAM_IMG and of the images DB_IMG can be compared in a pertinent manner by the controller AAAC 101. As a variant, the region-of-interest ROI information associated with the images DB_IMG is determined in real time by the controller AAAC 101 (by the comparator COMP 252) in the same way as for the images CAM_IMG.

The region-of-interest ROI extraction operations are techniques widely used in the image processing field and are not more fully described here.

In a step 405, the controller AAAC 101 performs a comparison of the images CAM_IMG and of the images DB_IMG designed to determine whether their associated regions of interest correspond (e.g., show a correlation peak). The comparison can be performed using a correlation function. In the particular arrangement of FIG. 3, the step 405 is performed by the comparator COMP 252.

In a step 406, the controller AAAC 101 determines whether the regions of interest ROI associated with the images CAM_IMG and in the compared images DB_IMG correspond, that is to say, whether they are similar with a predetermined tolerance margin. In the particular arrangement of FIG. 3, the step 406 is performed by the comparator COMP 252. If such is the case, the step 401 is reiterated; otherwise, a step 407 is performed.

In a particular embodiment, notably suited to airports that have several parallel landing runways, the controller AAAC 101 determines, as a function of the attitude of the aircraft 100 (as supplied by the avionics 200), whether the aircraft 100 is aligned on the expected landing runway (that which corresponds to the region of interest ROI associated with the images CAM_IMG). An alignment on a wrong landing runway is then considered by the controller AAAC 101 as a lack of correspondence between the regions of interest associated with the images CAM_IMG and in the images DB_IMG.

In a particular embodiment, each region of interest ROI of the images DB_IMG is associated with labels representative of the content of the region of interest ROI concerned. The labels are established by complying with a predefined naming. When the controller AAAC 101 finds one or more regions of interest ROI associated with the images CAM_IMG and in the images DB_IMG which correspond, the controller AAAC 101 checks, using the predefined naming, whether the label of the region of interest ROI of the images DB_IMG which corresponds with the region of interest ROI of the images CAM_IMG on which the aircraft 100 is aligned (to land) is representative of a landing runway. Preferentially, when an airport has several landing runways, the predefined naming makes it possible to know the landing runway with which the region of interest ROI exactly corresponds. The controller AAAC 101 then checks that the label of the region of interest ROI of the images DB_IMG which corresponds to the region of interest ROI of the images CAM_IMG on which the aircraft 100 is aligned (to land) is representative of the expected landing runway. That facilitates the detection of an alignment on a region of interest ROI that does not correspond to a landing runway or an unauthorized landing runway.

In the step 407, the controller AAAC 101 generates a signal SIG representative of a lack of correspondence between the regions of interest ROI associated with the images CAM_IMG and in the images DB_IMG, and therefore of a potential approach of the aircraft 100 to a landing area which does not correspond to the expected landing runway. The step 401 is then reiterated. In the particular arrangement of FIG. 3, the generation of the signal SIG is performed by the comparator COMP 252. In a particular embodiment, the signal SIG is generated only when the aircraft 100 is in approach phase, as known from the avionics 200, and more particularly by the flight management system FMS.

In an optional embodiment or as a variant, when the regions of interest ROI associated with the images CAM_IMG and in the compared images DB_IMG correspond, the controller AAAC 101 generates a signal SIG representative of a match between the regions of interest associated with the images CAM_IMG and in the images DB_IMG, and therefore of an approach of the aircraft 100 to a landing area which actually corresponds to the expected landing runway.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An airport approach assistance system for an aircraft, including a controller comprising electronic circuitry configured to:
obtain a first image captured by a camera configured to capture images of a field of view ahead of the aircraft;
obtain a second image stored in a database representing a runway, called expected landing runway, where the aircraft is supposed to land;
make changes to at least one of the first image or to the second image, in order to transpose them into a same spatial reference frame;
extract a first region of interest from the first image, so as to isolate a landing area in the first image;
compare the extracted first region of interest with a second region of interest associated with the second image; and
generate at least one of a signal representative of an approach to a landing area which does not correspond to the expected landing runway when the first region of interest and the second region of interest do not match, or a signal representative of an approach to a landing area which corresponds to the expected landing runway when the first region of interest and the second region of interest match.

2. The airport approach assistance system according to claim 1, further including the camera.

3. The airport approach assistance system according to claim 1, further including said database.

4. The airport approach assistance system according claim 1, wherein the changes to at least one of the first image or to the second image include reprojection operations.

5. The airport approach assistance system according to claim 1, wherein the electronic circuitry is configured to determine, as a function of an attitude of the aircraft, whether the aircraft is aligned on the expected landing runway, and, if not, generate the signal representative of an approach to a landing area which does not correspond to the expected landing runway.

6. The airport approach assistance system according to claim 5,
wherein the second region of interest of the second image is associated with a label representative of the content of the second region of interest, and
wherein the electronic circuitry is configured to check, using the label, that the aircraft is aligned on a landing runway.

7. An aircraft comprising a camera installed and configured to capture images of a field of view ahead of the aircraft, and the airport approach assistance system according to claim 1.

8. The aircraft according to claim 7, wherein the electronic circuitry of the controller of the airport approach assistance system is configured to transmit said signal to a human-machine interface of a cockpit of the aircraft.

9. A method implemented by electronic circuitry of a controller of an airport approach assistance system for an aircraft, the method including:
obtaining a first image captured by a camera configured to capture images of a field of view ahead of the aircraft;
obtaining a second image stored in a database representing a runway, called expected landing runway, where the aircraft is supposed to land;
making changes to at least one of the first image or to the second image, in order to transpose them into a same spatial reference frame;
extracting a first region of interest from the first image, so as to isolate a landing area in the first image;
comparing the first region of interest from the first image with a second region of interest associated with the second image; and
generating a signal representative of an approach to a landing area which does not correspond to the expected landing runway when the first region of interest and the second region of interest do not match and/or a signal representative of an approach to a landing area which corresponds to the expected landing runway when the first region of interest and the second region of interest match.

10. A non-transitory information storage medium storing a computer program comprising instructions for implementing the method according to claim 9, when said instructions are read from the information storage medium and executed by a processor.
